(19) United States
(12) Patent Application Publication
(10) Pub. No.: US 2017/0097790 A1
(43) Pub. Date: Apr. 6, 2017

(54) MEMORY MODULE AND SEMICONDUCTOR MEMORY SYSTEM INCLUDING THE SAME

(71) Applicant: Samsung Electronics Co., Ltd., Suwon-si (KR)

(72) Inventors: Su-yeon Doo, Seoul (KR); Tae-young Oh, Seoul (KR); Kwang-il Park, Yongin-si (KR)

(21) Appl. No.: 15/194,963

(22) Filed: Jun. 28, 2016

(30) Foreign Application Priority Data
Oct. 1, 2015 (KR) 10-2015-0138616

(51) Int. Cl. G06F 3/06; G06F 13/16

(52) U.S. Cl. CPC G06F 3/0634; G06F 3/061; G06F 3/0683; G06F 13/1668

(57) ABSTRACT

A memory module includes a first memory group including a plurality of first semiconductor memory devices, and a second memory group including a plurality of second semiconductor memory devices. The first semiconductor memory devices and the second semiconductor memory devices share a command/address bus. The first semiconductor memory devices perform a first operation in response to a command signal received by the first semiconductor memory devices from the command/address bus and the second semiconductor memory devices perform a second operation, different from the first operation, in response to the same command signal received by the second semiconductor memory devices from the command/address bus.

### CROSS-REFERENCE TO RELATED APPLICATION

This application claims priority under 35 USC §119(a) to Korean Patent Application No. 10-2015-0138616, filed on Oct. 1, 2015, in the Korean Intellectual Property Office, the disclosure of which is incorporated herein in its entirety by reference.

### BACKGROUND

The disclosure relates to a memory module and a semiconductor memory system including the same, and more particularly, to a memory module capable of increasing the efficiency of a command/address buffer and a semiconductor memory system including the memory module.

Semiconductor memory devices have been widely used in high-performance electronic systems, and the capacity and operational speed thereof have increased. Dynamic random access memory (DRAM) is an example of such semiconductor memory devices. DRAM is a volatile memory and determines data according to charges stored in a capacitor.

A memory controller provides various commands and addresses to a semiconductor memory device and controls various operations including a memory operation. A method of increasing efficiency of a command/address bus shared by semiconductor memory devices may be desired as demands for a semiconductor memory device capable of operating at high speed have increased.

### SUMMARY

Some exemplary embodiments of the present disclosure provide a semiconductor memory device capable of operating at high speed by efficiently using a command/address bus shared by semiconductor memory devices.

According to an exemplary embodiment of the present disclosure, there is provided a memory module including a first memory group including a plurality of first semiconductor memory devices, and a second memory group including a plurality of second semiconductor memory devices. The first semiconductor memory devices included in the first memory group and the second semiconductor memory devices included in the second memory group may share a command/address bus, and wherein the first semiconductor memory devices of the first memory group may perform a first operation in response to a command signal received by the first semiconductor memory devices from the command/address bus and the second semiconductor memory devices of the second memory group may perform a second operation, different from the first operation, in response to the same command signal received by the second semiconductor memory devices from the command/address bus.

In an exemplary embodiment, each of the first and second memory groups may be configured such that each of the first and second operations may be performed in units of memory ranks.

In an exemplary embodiment, each of the first semiconductor memory devices may perform the first operation in response to the command signal when the respective first semiconductor device is in a first state, and each of the second semiconductor memory devices may perform a second operation in response to the command signal when the respective second semiconductor device is in a second state.

In an exemplary embodiment, each of the second semiconductor memory devices may include an on-die termination (ODT) unit, the command signal is a read or write signal, and the first operation may be a data read/write operation from/into each of the first semiconductor memory devices, and the second operation may be a turn-on operation of the ODT unit in each of the second semiconductor memory devices.

In an exemplary embodiment, each of the first and second semiconductor memory devices may include a data input/output unit, and when a self-test is performed on the data input/output unit, the command signal may be a read signal, and the first operation may be a read operation of test data written in each of the first semiconductor memory devices, and the second operation may be a write operation of the test data which is read through the first operation into each of the second semiconductor memory devices.

In an exemplary embodiment, each of the first semiconductor memory devices may include a temperature sensor sensing an internal temperature and generating internal temperature information, and when setting a parameter of the first and second semiconductor memory devices, the command signal may be a transmission signal, and the first operation of each of the first semiconductor memory devices may be a transmission operation transmitting the internal temperature information to a corresponding second semiconductor memory device, and the second operation of each of the second semiconductor memory devices may be a receiving operation receiving the internal temperature information.

In an exemplary embodiment, when receiving a second state changing signal from the command/address bus, each of the second semiconductor memory devices may become a third state in response to the second state changing signal.

In an exemplary embodiment, each of the second semiconductor memory devices may perform a third operation in response to the command signal.

In an exemplary embodiment, the command signal may be a write signal, and the first operation may be a data-write operation into each of the first semiconductor memory devices, and the third operation may perform data-training operation on each of the second semiconductor memory devices.

According to another exemplary embodiment of the present disclosure, there is provided a semiconductor memory system including a memory module including a plurality of semiconductor memory devices sharing a command/address bus, and a controller configured to control the semiconductor memory devices by providing a command signal to the semiconductor memory devices via the command/address bus, and each semiconductor memory device of the semiconductor memory devices includes a state-based decoder configured to decode the command signal based on a state of the semiconductor memory device.

According to another exemplary embodiment, a memory module is disclosed. The memory module includes: a first semiconductor memory device including a first state decoder; and a second semiconductor memory device including a second state decoder, wherein the first semiconductor memory device and the second semiconductor memory device share a command/address bus, wherein the first state decoder is configured to decode a command signal, received via the command/address bus, into a first internal command signal, and the first semiconductor memory device is configured to perform a first type of operation based on the first internal command signal when it is determined that the first semiconductor memory device is in a first state, and wherein the second state decoder is configured to decode the same command signal, received via the command/address bus, into a second internal command signal, and the second semiconductor memory device is configured to perform a second type of operation based on the second internal command signal when it is determined that the second semiconductor memory device is in a second state.

In an exemplary embodiment, each of the first and second semiconductor memory devices comprises a data input/output unit, and when a self-test is performed on the data input/output unit, the command signal is a read signal, and the first operation is a read operation of test data written in the first semiconductor memory device, and the second operation is a write operation of the test data which is read through the first operation into the second semiconductor memory device.

### BRIEF DESCRIPTION OF THE DRAWINGS

Embodiments of the inventive concept will be more clearly understood from the following detailed description taken in conjunction with the accompanying drawings in which:

FIG. 1 is a schematic view of a memory module according to an exemplary embodiment of the inventive concept;

FIG. 2 is a schematic view of a semiconductor memory system including a memory module according to an exemplary embodiment of the inventive concept;

FIG. 3 is a view of a semiconductor memory system representing a configuration relationship between a memory controller and a memory module, according to an exemplary embodiment of the inventive concept;

FIG. 4 is a block diagram of a state-based decoder according to an exemplary embodiment of the inventive concept;

FIG. 5 is a block diagram illustrating operations of first and second semiconductor memory devices respectively included in first and second memory groups, according to an exemplary embodiment of the inventive concept;

FIG. 6 is a timing chart illustrating operations of the first and second semiconductor memory devices of FIG. 5, according to an exemplary embodiment of the inventive concept;

FIG. 7 is a block diagram illustrating operations of first and second semiconductor memory devices respectively included in first and second memory groups, according to another exemplary embodiment of the inventive concept;

FIG. 8 is a timing chart illustrating operations of the first and second semiconductor memory devices of FIG. 7, according to an exemplary embodiment of the inventive concept;

FIG. 9 is a block diagram illustrating operations of first and second semiconductor memory devices respectively included in first and second memory groups, according to another exemplary embodiment of the inventive concept;

FIG. 10 is a timing chart illustrating operations of the first and second semiconductor memory devices of FIG. 9, according to an exemplary embodiment of the inventive concept;

FIG. 11 is a block diagram of a state-based decoder according to another exemplary embodiment of the inventive concept;

FIG. 12 is a block diagram illustrating operations of first and second semiconductor memory devices respectively included in first and second memory groups, according to another exemplary embodiment of the inventive concept;

FIG. 13 is a timing chart illustrating operations of the first and second semiconductor memory devices of FIG. 12, according to an exemplary embodiment of the inventive concept;

FIG. 14 is a view of a data process system including a memory controller and a memory module according to an exemplary embodiment of the inventive concept; and

FIG. 15 is a block diagram of a computing system including a memory system, according to an exemplary embodiment of the inventive concept.

### DETAILED DESCRIPTION OF THE EMBODIMENTS

The present disclosure now will be described more fully hereinafter with reference to the accompanying drawings, in which various embodiments are shown. The invention may, however, be embodied in many different forms and should not be construed as limited to the example embodiments set forth herein. These example embodiments are just that—examples—and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention.

In the drawings, the size and relative sizes of layers and regions may be exaggerated for clarity. Like numbers refer to like elements throughout. Though the different figures show variations of exemplary embodiments, these figures are not necessarily intended to be mutually exclusive from each other. Rather, as will be seen from the context of the detailed description below, certain features depicted and described in different figures can be combined with other features from other figures to result in various embodiments, when taking the figures and their description as a whole into consideration.

Although the figures described herein may be referred to using language such as “one embodiment,” or “certain embodiments,” these figures, and their corresponding descriptions are not intended to be mutually exclusive from other figures or descriptions, unless the context so indicates. Therefore, certain aspects from certain figures may be the same as certain features in other figures, and/or certain figures may be different representations or different portions of a particular exemplary embodiment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “and/or” includes any and all combinations of one or more of the associated listed items and may be abbreviated as “/”.

It will be understood that, although the terms first, second, third etc. may be used herein to describe various elements, components, regions, layers and/or sections, these elements, components, regions, layers and/or sections should not be limited by these terms. Unless the context indicates otherwise, these terms are only used to distinguish one element, component, region, layer or section from another element, component, region, layer or section, for example as a naming convention. Thus, a first element, component, region, layer or section discussed below in one section of the specification could be termed a second element, component, region, layer or section in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, or as “contacting” or “in contact with” another element, there are no intervening elements present. Other words used to describe the relationship between elements should be interpreted in a like fashion (e.g., “between” versus “directly between,” “adjacent” versus “directly adjacent,” etc.).

Embodiments described herein will be described referring to plan views and/or cross-sectional views by way of ideal schematic views. Accordingly, the exemplary views may be modified depending on manufacturing technologies and/or tolerances. Therefore, the disclosed embodiments are not limited to those shown in the views, but include modifications in configuration formed on the basis of manufacturing processes. Therefore, regions exemplified in figures may have schematic properties, and shapes of regions shown in figures may exemplify specific shapes of regions of elements to which aspects of the invention are not limited.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Also these spatially relative terms such as “above” and “below” as used herein have their ordinary broad meanings—for example element A can be above element B even if when looking down on the two elements there is no overlap between them (just as something in the sky is generally above something on the ground, even if it is not directly above).

Terms such as “same,” “equal,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to reflect this meaning.

Terms such as “about” or “approximately” may reflect amounts, sizes, orientations, or layouts that vary only in a small relative manner, and/or in a way that does not significantly alter the operation, functionality, or structure of certain elements. For example, a range from “about 0.1 to about 1” may encompass a range such as a 0%-5% deviation around 0.1 and a 0% to 5% deviation around 1, especially if such deviation maintains the same effect as the listed range.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

As used herein, items described as being “electrically connected” are configured such that an electrical signal can be passed from one item to the other. Therefore, a passive electrically conductive component (e.g., a wire, pad, internal electrical line, etc.) physically connected to a passive electrically insulative component (e.g., a prepreg layer of a printed circuit board, an electrically insulative adhesive connecting two devices, an electrically insulative underfill or mold layer, etc.) is not electrically connected to that component. Moreover, items that are “directly electrically connected,” to each other are electrically connected through one or more passive elements, such as, for example, wires, pads, internal electrical lines, through vias, etc. As such, directly electrically connected components do not include components electrically connected through active elements, such as transistors or diodes. Directly electrically connected elements may be directly physically connected and directly electrically connected.

Components described as thermally connected or in thermal communication are arranged such that heat will follow a path between the components to allow the heat to transfer from the first component to the second component. Simply because two components are part of the same device or package does not make them thermally connected. In general, components which are heat-conductive and directly connected to other heat-conductive or heat-generating components (or connected to those components through intermediate heat-conductive components or in such close proximity as to permit a substantial transfer of heat) will be described as thermally connected to those components, or in thermal communication with those components. On the contrary, two components with heat-insulative materials therebetween, which materials significantly prevent heat transfer between the two components, or only allow for incidental heat transfer, are not described as thermally connected or in thermal communication with each other. The terms “heat-conductive” or “thermally-conductive” do not apply to a particular material simply because it provides incidental heat conduction, but are intended to refer to materials that are typically known as good heat conductors or known to have utility for transferring heat, or components having similar heat conducting properties as those materials.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

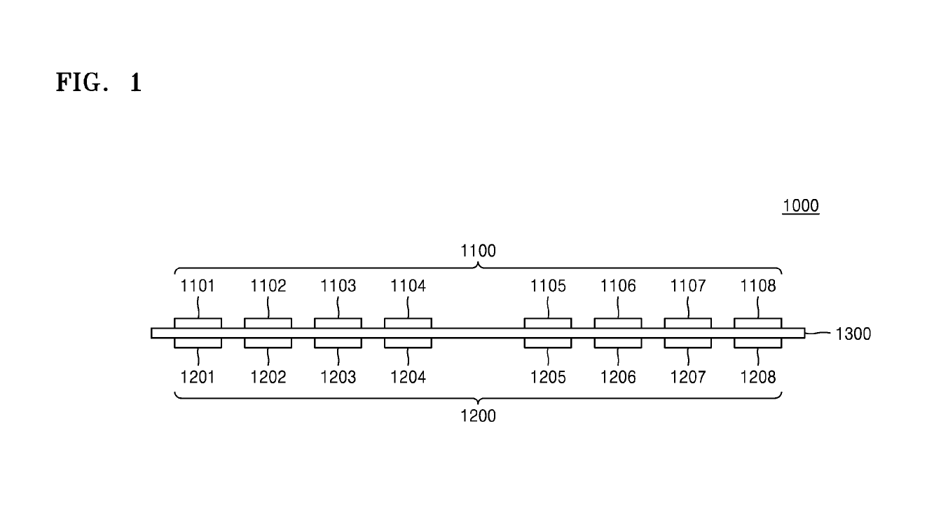

In some embodiments, as illustrated in FIG. 1, a memory module 1000 may include a first memory group 1100 and a second memory group 1200. In this exemplary embodiment, the first and second memory groups 1100 and 1200 may include eight semiconductor memory devices 1101 to 1108, and 1201 to 1208, respectively, but is limited thereto. The eight of the semiconductor memory devices 1101 to 1108 included in the first memory group 1100 may share an address signal and a command signal, and the data signals of each of the semiconductor memory devices may be respectively output or input to/from the outside of the memory module 1000 in parallel.

According to an exemplary embodiment of the inventive concept, the first and second memory groups 1100 and 1200 may receive a command signal via a shared command/address bus. The first and second memory groups 1100 and 1200 may perform operations different from each other in response to the command signal. This will be described below in detail. Different operations may refer to different types of operations, e.g., a read operation or a write operation, parameter setting operation, a transmission operation, a receiving operation, a training operation, etc. The command signal received at devices of the first and second memory groups 1100 and 1200 may be the same signal, for example, a read signal, write signal, etc. In certain descriptions herein, the command signal received at the devices of the first and second memory groups 1100 and 1200 may be described as a command signal having a type (e.g., read, write, etc.), such that the type of signal received at devices of the first and second memory groups 1100 and 1200 is the same.

According to an exemplary embodiment of the inventive concept, the semiconductor memory devices 1101 to 1008 and 1201 to 1208 respectively included in the first and second memory groups 1100 and 1200 may include dynamic random access memory (DRAM). FIG. 1 illustrates an exemplary embodiment in which one memory group includes eight semiconductor memory devices, but in other embodiments, the number of the semiconductor memory devices may be less or greater than eight.

As used herein, a semiconductor device may refer to a device such as a semiconductor chip (e.g., memory chip and/or logic chip formed on a die), a stack of semiconductor chips, a semiconductor package including one or more semiconductor chips stacked on a package substrate, or a package-on-package device including a plurality of packages. These devices may be formed using ball grid arrays, wire bonding, through substrate vias, or other electrical connection elements, and may include memory devices such as volatile or non-volatile memory devices.

In some embodiments, if the memory operation of the first and second memory groups 1100 and 1200 is performed in units of memory ranks, a width of a data signal which is simultaneously input/output to/from the memory module 1000 with other data signals may be the same as that of data input/output to/from a rank.

In some embodiments, the memory module 1000 may be a registered dual in-line memory module (RDIMM), but is not limited thereto. According to example embodiments, the memory module 1000 may also be an unbuffered dual in-line memory module (UDIMM), a fully buffered dual in-line memory module (FBDIMM), a load reduced dual in-line memory module (LRDIMM), etc. A memory buffer or a register clock driver (RCD) may be located between semiconductor memory devices included in a memory module and a memory controller, and reduce a load to the memory module from the memory controller. Therefore, the memory controller may control a plurality of memory modules.

In some embodiments, the semiconductor memory devices 1101 to 1108 included in the first memory group 1100 and the semiconductor memory devices 1201 to 1208 included in the second memory group 1200 may be attached to a substrate 1300. The substrate 1300 could be, for example, a module board. The substrate 1300 may include an electric conductor (not shown in FIG. 1) and may electrically connect components of the memory module 1000 attached to the substrate 1300 by using the electric conductor. In some embodiments, the substrate 1300 may include terminals (not shown in FIG. 1) for signal transmission, in which the memory module 1000 transmits and receives the signal with an external device (for example, a memory system).

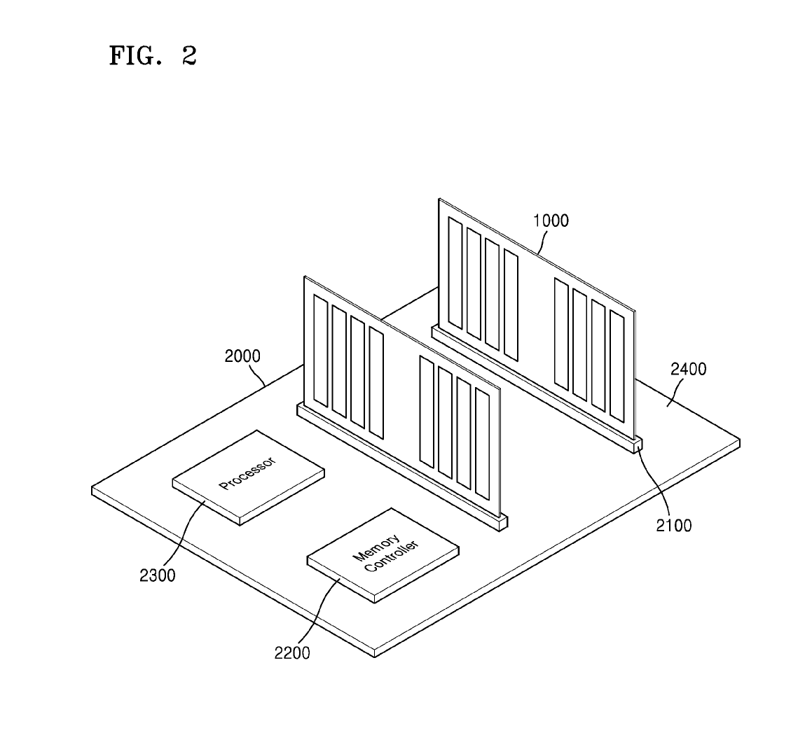

FIG. 2 is a schematic view of a semiconductor memory system 2000 including a memory module according to an exemplary embodiment of the inventive concept. As illustrated in FIG. 2, the semiconductor memory system 2000 may include a socket 2100, a memory controller 2200, a processor 2300 and a substrate 2400. The socket 2100, the memory controller 2200, and the processor 2300 may be attached on the substrate 2400 and may be electrically connected to each other via an electric conductor included in the substrate 2400. FIG. 2 illustrates an exemplary embodiment of the memory module 1000 provided on the semiconductor memory system 2000 according to an exemplary embodiment. However, the memory module 1000 may be separated from the semiconductor memory system 2000 in other embodiments. According to an exemplary embodiment of the inventive concept, the semiconductor memory system 2000 may be a main board or a computing system on which the memory module 1000 may be provided, and the memory module may function as data memory in the semiconductor memory system 2000.

As illustrated in FIG. 2, the socket 2100 may be attached on the substrate 2400. The memory module 1000 may be installed in the semiconductor memory system 2000 via the socket 2100, and may be electrically connected to other components of the semiconductor memory system 2000 via the socket 2100. For example, the memory module 1000 may be electrically connected to the memory controller 2200 via the socket 2100 and the substrate 2400. In some embodiments, the semiconductor memory system 2000 may of FIG. 2 may include at least three sockets 2100. Accordingly, at least three memory modules 1000 may be provided on the semiconductor memory system 2000.

According to an exemplary embodiment of the inventive concept, the memory controller 2200 may output a command signal for controlling the memory module 1000 provided on the semiconductor memory system 2000, and may receive data from the memory module 1000. The processor 2300 may control the memory controller 2200 to write or read data in/from the memory module 1000. For example, the processor 2300 may transmit data to write in the memory module 1000 to the memory controller 2200, and the memory controller 2200 may output a command signal suitable for the memory module 1000 to write the data received from the processor 2300 in the memory module 1000.

According to an exemplary embodiment of the inventive concept, the memory controller 2200 may output a command signal for controlling the memory module 1000. In some embodiments, the memory controller 2200 may provide a chip selection signal based on a state of a semiconductor memory device included in the memory module 1000. For example, the semiconductor memory devices 1101 to 1008 and 1201 to 1208 respectively included in the first and second memory groups 1100 and 1200 may be in different states, and may perform different operations in response to the same command signal. This will be described below in detail.

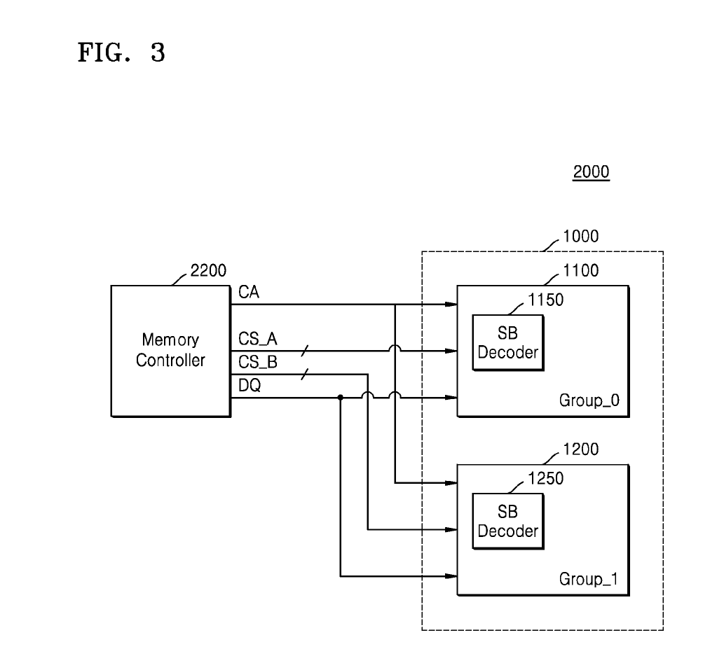

FIG. 3 is a view of a semiconductor memory system 2000 representing a configuration relationship between a memory controller 2200 and a memory module 1000, according to an exemplary embodiment of the inventive concept. FIG. As illustrated in FIG. 3, the semiconductor memory system 2000 may include the memory module 1000 and the memory controller 2200. The memory module 1000 may include first and second memory groups Group_0 and Group_1 each including a plurality of semiconductor memory devices. The memory controller 2200 may provide a variety of control signals to control each of the memory groups Group_0 and Group_1. The memory controller 2200 may provide a command/address signal, a plurality of chip selection signals CS_A and CS_B, a data signal to each of the memory groups Group_0 and Group_1.

According to an exemplary embodiment of the inventive concept, the semiconductor memory devices respectively included in the first and second memory groups Group_0 and Group_1 may share at least one of a command/address bus CA and a data bus DQ. Therefore, the memory controller 2200 may provide an identical command signal to the first and second memory groups Group_0 and Group_1.

According to an exemplary embodiment of the inventive concept, the semiconductor memory devices included in the first and second memory groups Group_0 and Group_1 may respectively perform different operations in response to the command signal according to respective states thereof. For example, the semiconductor memory devices included in the first memory group Group_0 may be in a first state, and the semiconductor memory devices included in the second memory group Group_1 may be in a second state different than the first state. In an exemplary embodiment, a state of a semiconductor memory device may be a target state indicating a state of a semiconductor memory device to be controlled by a write operation or a read operation, or a non-target state indicating a state of a semiconductor memory device not to be controlled by a write operation or a read operation. However, this is only an example and a state of a semiconductor memory device is not limited to the above states.

In some embodiments, the semiconductor memory devices included in the first memory group Group_0 may perform a first operation in response to a command signal, and the semiconductor memory devices included in the second memory group Group_1 may perform a second operation in response to a command signal. In some embodiments, states of the semiconductor memory devices may change according to a state changing signal received from the memory controller 2200.

In some embodiments, semiconductor memory devices included in one memory group may have the same state.

According to an exemplary embodiment of the inventive concept, the first memory group Group_0 may include state-based decoders 1150 and the second memory group Group_1 may include state-based decoders 1250. Although, for convenience of explanation, the state-based decoders 1150 and 1250 are illustrated as being directly included in the memory groups Group_0 and Group_1, the state-based decoders 1150 and 1250 may be included in a plurality of semiconductor memory devices in the memory groups Group_0 and Group_1. The state-based decoders 1150 and 1250 may receive the same command signal via the command/address bus CA shared by the plurality of semiconductor memory devices of the memory groups Group_0 and Group_1, and the state-based decoders 1150 and 1250 may decode the same command signal into respective internal command signals according to each state of the semiconductor memory devices.

For example, when the semiconductor memory device included in the first memory group Group_0 is in a first state, the state-based decoder 1150 decodes the received command signal into a first internal command signal, and the semiconductor memory device included in the first memory group Group_0 may perform the first operation based on the first internal command signal. Furthermore, when the semiconductor memory device included in the second memory group Group_1 is in a second state, the state-based decoder 1250 decodes the received command signal into a second internal command signal, and the semiconductor memory device included in the second memory group Group_1 may perform the second operation based on the second internal command signal.

A semiconductor memory system according to an exemplary embodiment of the inventive concept may control different operations of respective semiconductor memory devices by memory group units through one command signal. Therefore, by reducing the number of retransmission times of the command signal, efficiency of a command/address bus may increase and a semiconductor memory system operating at high speed may be provided.

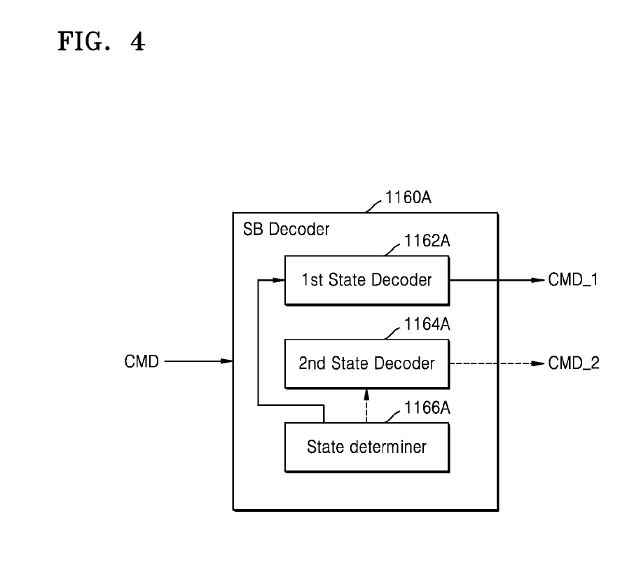

FIG. 4 is a block diagram of a state-based decoder 1160A according to an exemplary embodiment of the inventive concept. As illustrated in FIG. 4, the state-based decoder 1160A may include a first state decoder 1162A, a second state decoder 1164A, and a state determiner 1166A. The state determiner 1166A may determine a state of a semiconductor memory device and control a decoding operation corresponding to a command signal CMD based on the state of the semiconductor memory device. According to the embodiment, when the state of the semiconductor memory device is a first state, the state determiner 1166A may control the first state decoder 1162A to decode the command signal CMD into a first internal command signal CMD_1. According to this exemplary embodiment, when the state of the semiconductor memory device is a second state, the state determiner 1166A may control the second state decoder 1164A to decode the command signal CMD into a second internal command signal CMD_2. In an exemplary embodiment, according to the state of the semiconductor memory device, the state determiner 1166A may control the decoding operation by controlling on/off of the first and second state decoders 1162A and 1164A.

In an exemplary embodiment, the first state may be a target state indicating a state of a semiconductor memory device to be controlled by a write operation or a read operation, and the second state may be a non-target state indicating a state of a semiconductor memory device not to be controlled by a write operation or a read operation.

In some embodiments, when the command signal CMD is a state changing signal and a state of the semiconductor memory device changes to another state, the state determiner 1166A may determine the changed state and control a decoding operation corresponding to a command signal CMD based on the changed state when the command signal CMD is received again.

According to an exemplary embodiment of the inventive concept, the state-based decoder 1160A may decode the command signal CMD into the first and second internal command signals CMD_1 and CMD_2 based on a state of the semiconductor memory device. When decoding the command signal CMD into the first internal command signal CMD_1, the semiconductor memory device may perform a first operation in response to the first internal command signal CMD_1. When decoding the command signal CMD into the second internal command signal CMD_2, the semiconductor memory device may perform a second operation in response to the second internal command signal CMD_2.

As such, the semiconductor memory device according to an exemplary embodiment of the inventive concept, which includes the state-based decoder 1160A, may reduce the number of retransmission times of a command signal by decoding the command signal into an internal command signal according to a state of the semiconductor memory device.

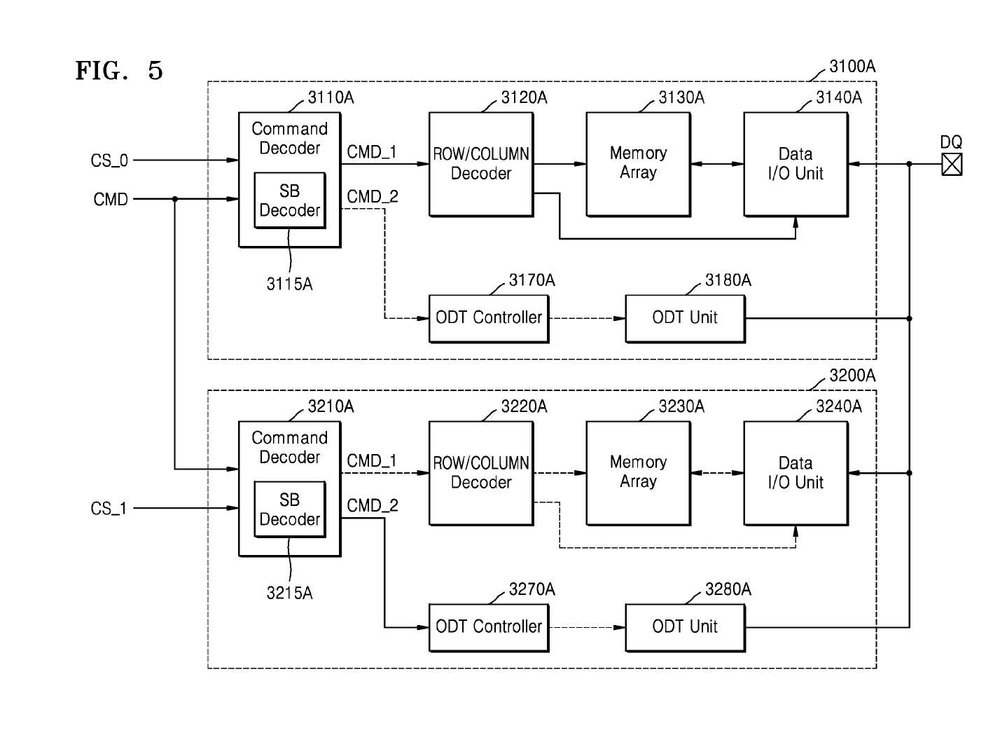

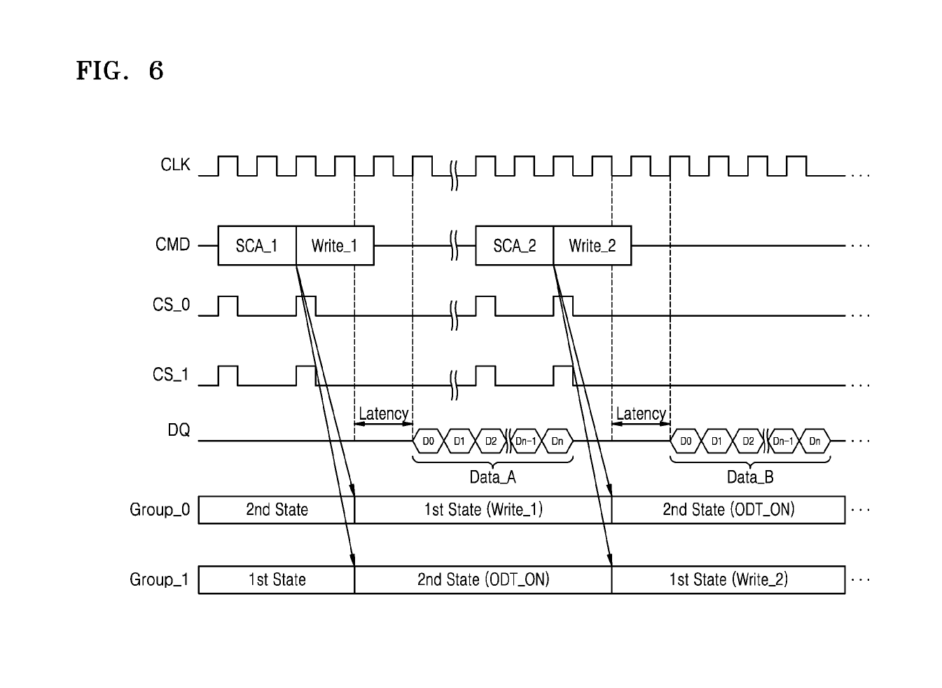

FIG. 5 is a block diagram illustrating operations of first and second semiconductor memory devices 3100A and 3200A respectively included in first and second memory groups, according to an exemplary embodiment of the inventive concept. FIG. 6 is a timing chart illustrating operations of the first and second semiconductor memory devices 3100A and 3200A of FIG. 5, according to an exemplary embodiment of the inventive concept.

As illustrated in FIG. 5, the first semiconductor memory device 3100A is included in the first memory group 1100 of FIG. 1, and the second semiconductor memory device 3200A is included in the second memory group 1200 of FIG. 1.

The first semiconductor memory device 3100A may include a command decoder 3110A, a row/column decoder 3120A, a memory array 3130A, a data input/output unit 3140A (e.g., a data input/out circuitry), an on-die termination (ODT) controller 3170A, and an ODT unit 3180A (e.g., an ODT circuitry). The command decoder 3110A may include a state-based decoder 3115A. The second semiconductor memory device 3200A may have same configuration as the first semiconductor memory device 3100A. For example, the second semiconductor memory device 3200A may include a command decoder 3210A, a row/column decoder 3220A, a memory array 3230A, a data input/output unit 3240A (e.g., a data input/out circuitry), an on-die termination (ODT) controller 3170A, and an ODT unit 3180A (e.g., an ODT circuitry). According to an exemplary embodiment, the first and second semiconductor memory devices 3100A and 3200A may share a command/address bus CA (e.g., as shown in FIG. 3) and a data bus DQ and may receive a command signal CMD via the shared command/address bus CA and a data signal via the shared data bus DQ. In some embodiments, a first chip selection signal CS_0 selecting the first semiconductor memory device 3100A and a second chip selection signal CS_1 selecting the second semiconductor memory device 3200A may be respectively received through different buses. For example, the command decoder 3110A of the first semiconductor device 3100A may receive the first chip selection signal CS_0 via a first bus and the command decoder 3210A of the second semiconductor device 3200A may receive the second chip selection signal CS_1 via a second bus different from the first bus.

Hereinafter, a first state changing signal may be indicated as a state changing signal A, and a second state changing signal may be indicated as a state changing signal B.

In some embodiments, referring to FIGS. 5 and 6, the first semiconductor memory device 3100A, which is in a second state, may receive a first state changing signal A SCA_1 and the first chip selection signal CS_0 activating the first semiconductor memory device 3100A through the shared command/address bus CA. Therefore, the first semiconductor memory device 3100A may be changed to a first state after the prescribed latency. The second semiconductor memory device 3200A, which is in a first state, may receive a first state changing signal A SCA_1 and the second chip selection signal CS_1 activating the second semiconductor memory device 3200A through the shared command/address bus CA. Therefore, the second semiconductor memory device 3200A may be changed to a second state after the prescribed latency.

In some embodiments, referring to FIGS. 5 and 6, the first semiconductor memory device 3100A may receive a first write signal Write_1 and the first chip selection signal CS_0 activating the first semiconductor memory device 3100A. The state-based decoder 3115A of the first semiconductor memory device 3100A may determine that the first semiconductor memory device 3100A is in a first state and may decode the first write signal Write_1 into a first internal command signal CMD_1. The first internal command signal CMD_1 may be a write signal for controlling a write operation of data in the memory array 3130A. The first internal command signal CMD_1 may be received by the row/column decoder 3120A of the first semiconductor memory device 3100A and may output a decoded signal to the memory array 3130A of the first semiconductor memory device 3100A. Therefore, the first semiconductor memory device 3100A, in response to the first write signal Write_1, may write first data Data_A sent from the data bus DQ to the data input/output unit 3140A in the memory array 3130A after the prescribed latency.

In some embodiments, referring to FIGS. 5 and 6, the second semiconductor memory device 3200A may receive a first write signal Write_1 and the second chip selection signal CS_1 activating the second semiconductor memory device 3200A. The state-based decoder 3215A of the second semiconductor memory device 3200A may determine that the second semiconductor memory device 3200A is in a second state and may decode the first write signal Write_1 into a second internal command signal CMD_2. The second internal command signal CMD_2 may be an ODT_ON signal provided to an ODT controller 3270A to turn on an ODT unit 3280A including ODT resistance. The ODT controller 3270A may turn on the ODT unit 3280A in response to the ODT_ON signal. In an exemplary embodiment, the ODT controller 3270A may receive a prescribed code from a mode register set (MRS) (not shown) included in the second semiconductor memory device 3200A and may control a resistance value of the ODT unit 3280A. The second semiconductor memory device 3200A may turn on the ODT unit 3280A in response to the first write signal Write_1.

Afterwards, the first semiconductor memory device 3100A, which is in a first state, may receive a second state changing signal A SCA_2 and the first chip selection signal CS_0 activating the first semiconductor memory device 3100A through the shared command/address bus CA. Therefore, the first semiconductor memory device 3100A may be changed to a second state after the prescribed latency. The second semiconductor memory device 3200A, which is in a second state, may receive the second state changing signal A SCA_2 and the second chip selection signal CS_1 activating the second semiconductor memory device 3200A through the shared command/address bus CA. Therefore, the second semiconductor memory device 3200A may be changed to a first state after the prescribed latency.

In some embodiments, the first semiconductor memory device 3100A may receive a second write signal Write_2 and the first chip selection signal CS_0 activating the first semiconductor memory device 3100A. The state-based decoder 3115A of the first semiconductor memory device 3100A may determine that the first semiconductor memory device 3100A is in a second state and may decode the second write signal Write_2 to the second internal command signal CMD_2. The second internal command signal CMD_2 may be an ODT_ON signal provided to an ODT controller 3170A to turn on the ODT unit 3180A including ODT resistance. The ODT controller 3170A may turn on the ODT unit 3180A in response to the ODT_ON signal. In an exemplary embodiment, the ODT controller 3270A may receive a prescribed code from an MRS (not shown) included in the first semiconductor memory device 3100A and may control a resistance value of the ODT unit 3180A. The first semiconductor memory device 3100A may turn on the ODT unit 3180A in response to the second write signal Write_2.

In some embodiments, the second semiconductor memory device 3200A may receive the second write signal Write_2 and the second chip selection signal CS_1 activating the second semiconductor memory device 3200A. The state-based decoder 3215A of the second semiconductor memory device 3200A may determine that the second semiconductor memory device 3200A is in a first state and may decode the first write signal Write_1 into the first internal command signal CMD_1. The first internal command signal CMD_1 may be a write signal for controlling a write operation of data in the memory array 3230A. The first internal command signal CMD_1 may be received by the row/column decoder 3220A of the second semiconductor memory device 3200A and may output a decoded signal to the memory array 3230A of the second semiconductor memory device 3200A. Therefore, the second semiconductor memory device 3200A, in response to the second write signal Write_2, may write second data Data_B sent from the data bus DQ to the data input/output unit 3240A in the memory array 3230A after the prescribed latency. However, the first and second semiconductor memory devices 3100A and 3200A are not limited to the above descriptions and may perform a read operation or an operation of turning on the ODT units 3180A and 3280A according to each state of the first and second semiconductor memory devices 3100A and 3200A when receiving a read signal.

According to the exemplary embodiments described above, a plurality of semiconductor memory devices included in the first memory group 1100 of FIG. 1 may operate like the first semiconductor memory device 3100A, and a plurality of semiconductor memory devices included in the second memory group 1200 of FIG. 1 may operate like the second semiconductor memory device 3200A.

Therefore, even though the same command signal is received, the first and second semiconductor memory devices 3100A and 3200A may perform respective operations according to respective states thereof. As a result, the number of retransmission times of the command signal may decrease and efficiency of the command/address bus CA may increase.

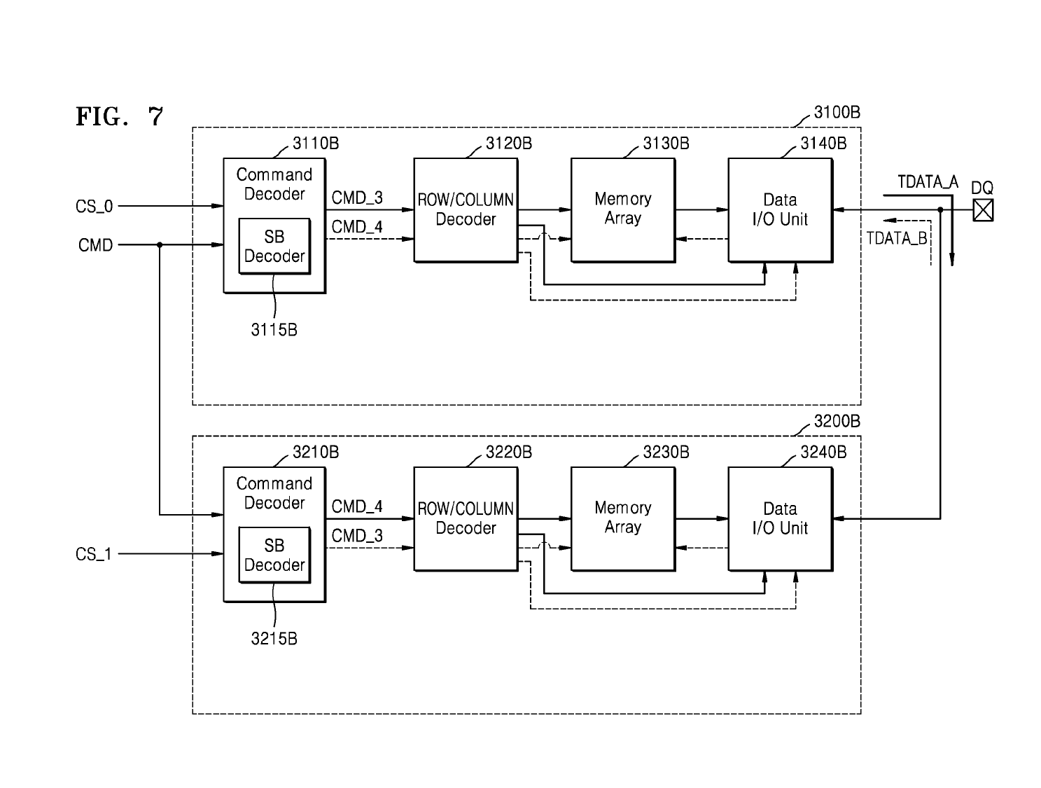

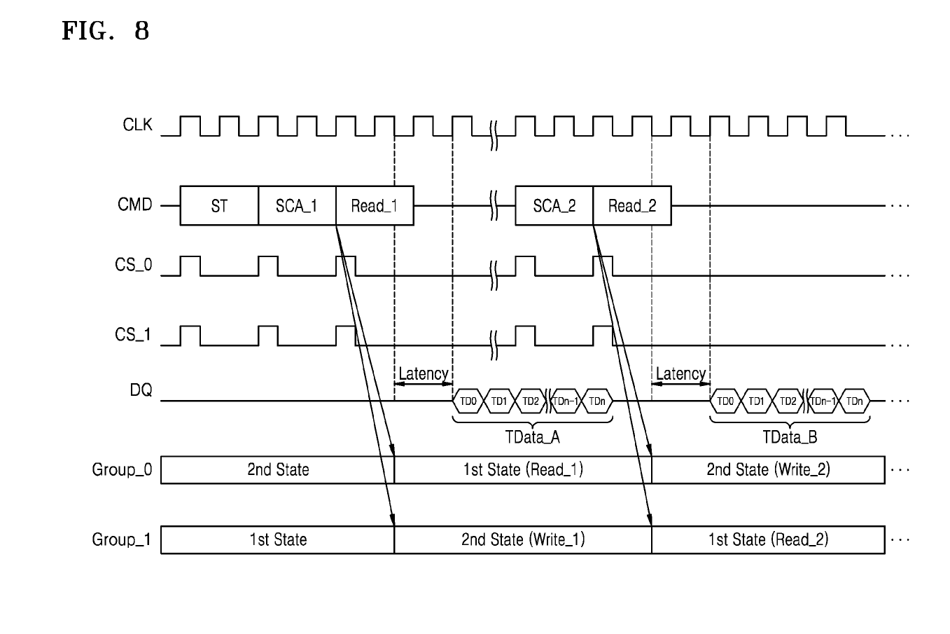

FIG. 7 is a block diagram illustrating operations of first and second semiconductor memory devices 3100B and 3200B respectively included in first and second memory groups, according to another embodiment of the inventive concept. FIG. 8 is a timing chart illustrating operations of the first and second semiconductor memory devices 3100B and 3200B of FIG. 7, according to an exemplary embodiment of the inventive concept.

As illustrated in FIG. 7, in this exemplary embodiment, the first semiconductor memory device 3100B is included in the first memory group 1100 of FIG. 1, and the second semiconductor memory device 3200B is included in the second memory group 1200 of FIG. 1.

The first semiconductor memory device 3100B may include a command decoder 3110B, a row/column decoder 3120B, a memory array 3130B, and a data input/output unit 3140B. The command decoder 3110A may include a state-based decoder 3115B. The second semiconductor memory device 3200B may have same configuration as the first semiconductor memory device 3100B. For example, the second semiconductor memory device 3200B may include a command decoder 3210B, a row/column decoder 3220B, a memory array 3230B, and a data input/output unit 3240B. The command decoder 3210A may include a state-based decoder 3215B. In some embodiments, the first and second semiconductor memory devices 3100B and 3200B may share a command/address bus CA and a data bus DQ and may receive a command signal CMD via the command/address but CA and a data signal via the data bus DQ. A first chip selection signal CS_0 selecting the first semiconductor memory device 3100B and a second chip selection signal CS_1 selecting the second semiconductor memory device 3200B may be respectively received through different buses. For example, the command decoder 3110B of the first semiconductor device 3100B may receive the first chip selection signal CS_0 via a first bus and the command decoder 3210B of the second semiconductor device 3200B may receive the second chip selection signal CS_1 via a second bus different from the first bus.

Referring to FIGS. 7 and 8, in some embodiments, modes of the first and second semiconductor memory devices 3100B and 3200B may be converted from normal operation modes into self-test operation modes to test data input/output units 3140B and 3240B, respectively. For example, the first and second semiconductor memory devices 3100B and 3200B may receive a self-test signal ST, and the first and second chip selection signals CS_0 and CS_1 respectively activating the first and second semiconductor memory devices 3100B and 3200B. Based on receiving the self-test signal ST, modes of the first and second semiconductor memory devices 3100B and 3200B may be converted from normal operation modes into self-test operation modes.

In this exemplary embodiment, the first semiconductor memory device 3100B, which is in a second state, may receive a first state changing signal A SCA_1 and the first chip selection signal CS_0 activating the first semiconductor memory device 3100B through the shared command/address bus CA. Therefore, the first semiconductor memory device 3100B may be changed to a first state after the prescribed latency. The second semiconductor memory device 3200B, which is in a first state, may receive the first state changing signal A SCA_1 and the second chip selection signal CS_1 activating the second semiconductor memory device 3200A through the shared command/address bus CA. Therefore, the second semiconductor memory device 3200A may be changed to a second state after the prescribed latency.

In this exemplary embodiment, the first semiconductor memory device 3100B may receive a first read signal Read_1 and the first chip selection signal CS_0 activating the first semiconductor memory device 3100B. The state-based decoder 3115B of the first semiconductor memory device 3100B may determine that the first semiconductor memory device 3100B is in a first state and may decode the first read signal Read_1 to a first internal command signal CMD_3. The first internal command signal CMD_3 may be a read signal for controlling a read operation of data written in the memory array 3130B. The first internal command signal CMD_3 may be received by the row/column decoder 3120B of the first semiconductor memory device 3100B and may output a decoded signal to the memory array 3130B of the first semiconductor memory device 3100B. Therefore, the first semiconductor memory device 3100B may read the data written in the memory array 3130B in response to the first read signal Read_1 after the prescribed latency. The first semiconductor memory device 3100B may transmit the read data, as first test data TDATA_A, to the second semiconductor memory device 3200B via the data bus DQ.

According to an exemplary embodiment, the second semiconductor memory device 3200B may receive the first read signal Read_1 and the second chip selection signal CS_1 activating the second semiconductor memory device 3200B. The state-based decoder 3215B of the second semiconductor memory device 3200B may determine that the second semiconductor memory device 3200B is in a second state and may decode the first read signal Read_1 to a second internal command signal CMD_4. The second internal command signal CMD_4 may be a write signal to control an operation of writing the first test data TDATA_A received via the data bus DQ in the memory array 3230B. The second internal command signal CMD_4 may be received by the row/column decoder 3220B of the second semiconductor memory device 3200B and may output a decoded signal to the memory array 3230B of the second semiconductor memory device 3200B. Therefore, the second semiconductor memory device 3200B may write the first test data TDATA_A received via the data bus DQ in the memory array 3230B in response to the first read signal Read_1 after the prescribed latency.

The memory controller 2200 of FIG. 3 may respectively test the data input/output units 3140B and 3240B by comparing first test data TDATA_A written in the memory array 3130B of the first semiconductor memory device 3100B with the first test data TDATA_A written in the memory array 3230B of the second semiconductor memory device 3200B.

Afterwards, the first semiconductor memory device 3100B, which is in a first state, may receive the second state changing signal A SCA_2 and the first chip selection signal CS_0 activating the first semiconductor memory device 3100B through the shared command/address bus CA. Therefore, the first semiconductor memory device 3100B may be changed to a second state after the prescribed latency. The second semiconductor memory device 3200B, which is in a second state, may receive the second state changing signal A SCA_2 and the second chip selection signal CS_1 activating the second semiconductor memory device 3200B through the shared command/address bus CA. Therefore, the second semiconductor memory device 3200B may be changed to a first state after the prescribed latency.

In an exemplary embodiment, the second semiconductor memory device 3200B may receive the second read signal Read_2 and the second chip selection signal CS_1 activating the second semiconductor memory device 3200B. The state-based decoder 3215B of the second semiconductor memory device 3200B may determine that the second semiconductor memory device 3200B is in a first state and may decode the second read signal Read_2 to the first internal command signal CMD_3. The first internal command signal CMD_3 may be a read signal for controlling a read operation of data written in the memory array 3230B. The first internal command signal CMD_3 may be received by the row/column decoder 3220B of the second semiconductor memory device 3200B and may output a decoded signal to the memory array 3230B of the second semiconductor memory device 3200B. Therefore, the second semiconductor memory device 3200B may read the data written in the memory array 3230B in response to the second read signal Read_2 after the prescribed latency. The second semiconductor memory device 3200B may transmit the read data, as second test data TDATA_B, to the first semiconductor memory device 3100B via the data bus DQ.

The first semiconductor memory device 3100B may receive the second read signal Read_2 and the first chip selection signal CS_0 activating the first semiconductor memory device 3100B. The state-based decoder 3115B of the first semiconductor memory device 3100B may determine that the first semiconductor memory device 3100B is in a second state and may decode the second read signal Read_2 to the second internal command signal CMD_4. The second internal command signal CMD_4 may be a write signal to control an operation of writing the second test data TDATA_B received via the data bus DQ in the memory array 3230B. The second internal command signal CMD_4 may be received by the row/column decoder 3120B of the first semiconductor memory device 3100B and may output a decoded signal to the memory array 3130B of the first semiconductor memory device 3100B. Therefore, the first semiconductor memory device 3100B may write the second test data TDATA_B received via the data bus DQ in the memory array 3130B in response to the second read signal Read_2 after the prescribed latency.

In some embodiments, the memory controller 2200 of FIG. 3 may respectively test the data input/output units 3140B and 3240B by comparing second test data TDATA_B written in the memory array 3130B of the first semiconductor memory device 3100B with second test data TDATA_B written in the memory array 3230B of the second semiconductor memory device 3200B.

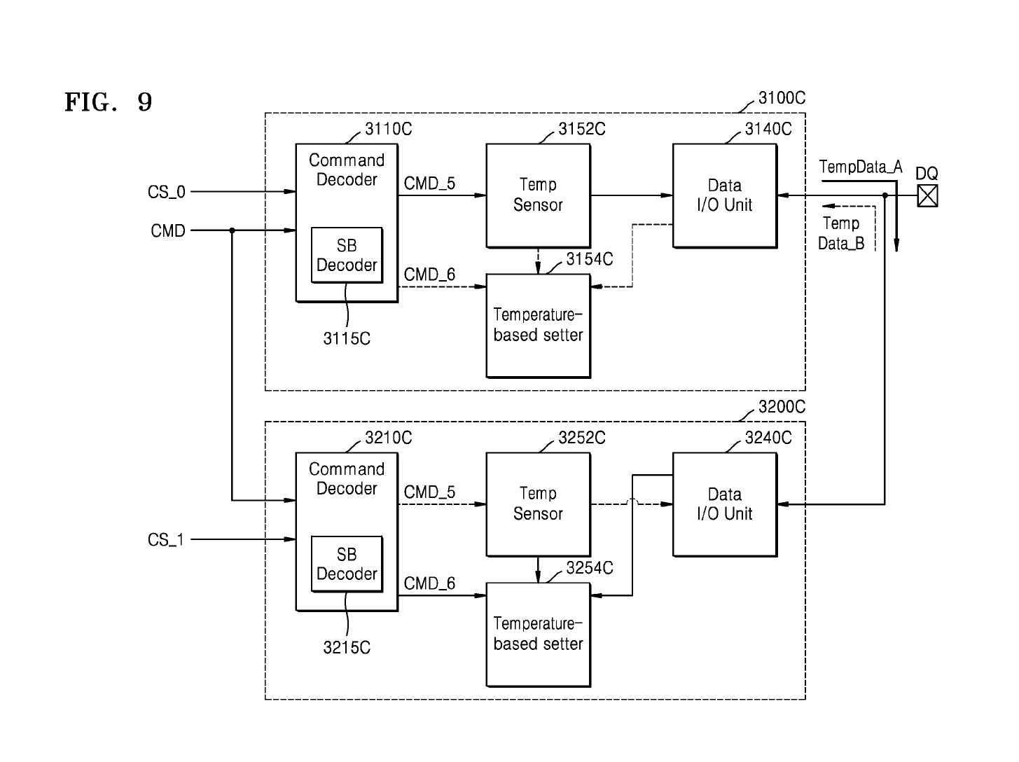

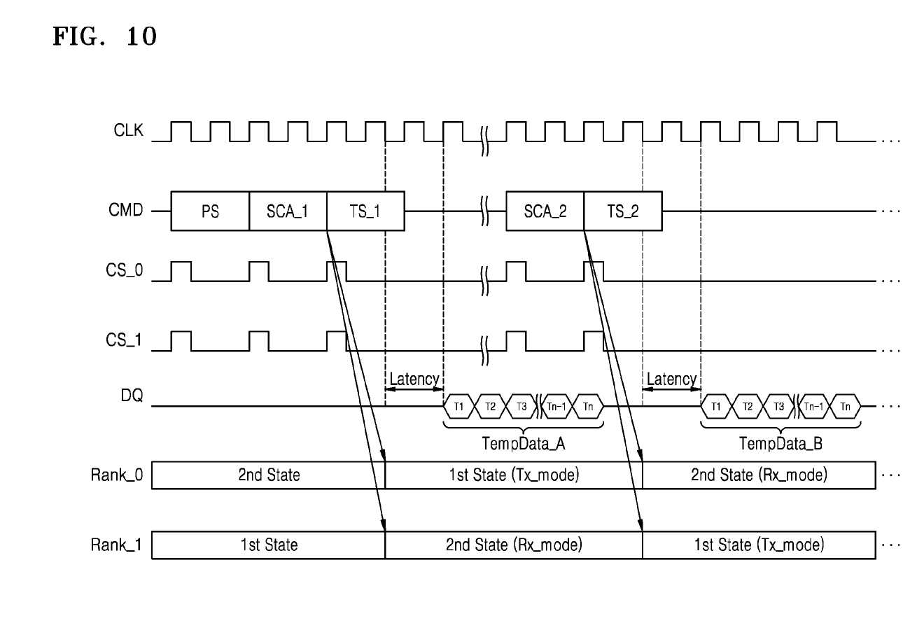

FIG. 9 is a block diagram illustrating operations of first and second semiconductor memory devices 3100C and 3200C respectively included in first and second memory groups, according to another embodiment of the inventive concept. FIG. 10 is a timing chart illustrating operations of the first and second semiconductor memory devices 3100C and 3200C of FIG. 9, according to an exemplary embodiment of the inventive concept.

As illustrated in FIG. 9, the first semiconductor memory device 3100C is included in the first memory group 1100 of FIG. 1, and the second semiconductor memory device 3200C is included in the second memory group 1200 of FIG. 1.

The first semiconductor memory device 3100C may include a command decoder 3110C, a temperature sensor 3152C, a temperature-based setter 3154C, and a data input/output unit 3140C. The command decoder 3110C may include a state-based decoder 3115C. The second semiconductor memory device 3200C may have same configuration as the first semiconductor memory device 3100C. For example, the second semiconductor memory device 3100C may include a command decoder 3210C, a temperature sensor 3252C, a temperature-based setter 3254C, and a data input/output unit 3240C. The command decoder 3210C may include a state-based decoder 3215C. In this exemplary embodiment, the first and second semiconductor memory devices 3100C and 3200C may share a command/address bus CA and a data bus DQ and may receive a command signal CMD through the shared command/address bus CA and a data signal thorough the data bus DQ. A first chip selection signal CS_0 selecting the first semiconductor memory device 3100C and a second chip selection signal CS_1 selecting the second semiconductor memory device 3200C may be respectively received through different buses. For example, the command decoder 3110C of the first semiconductor device 3100C may receive the first chip selection signal CS_0 through a first bus and the command decoder 3210C of the second semiconductor device 3200C may receive the second chip selection signal CS_1 through a second bus different from the first bus.

Referring to FIGS. 9 and 10, in an exemplary embodiment, modes of the first and second semiconductor memory devices 3100C and 3200C may be converted from normal operation modes into setting modes to set parameters of a semiconductor memory device such as a data input/output speed or a data read/write speed. The first and second semiconductor memory devices 3100C and 3200C may receive a parameter setting signal PS from the shared command/address bus CA, and may further receive the first and second chip selection signals CS_0 and CS_1 activating the first semiconductor memory device 3200C, respectively. Afterwards, the modes of the first and second semiconductor memory devices 3100C and 3200C may be converted from normal operation modes into parameter setting modes.

In this exemplary embodiment, the first semiconductor memory device 3100C, which is in a second state, may receive a first state changing signal A SCA_1 and the first chip selection signal CS_0 activating the first semiconductor memory device 3100C through the shared command/address bus CA. Therefore, the first semiconductor memory device 3100C may be changed to a first state after the prescribed latency. The second semiconductor memory device 3200C, which is in a first state, may receive the first state changing signal A SCA_1 and the second chip selection signal CS_1 activating the second semiconductor memory device 3200C through the shared command/address bus CA. Therefore, the second semiconductor memory device 3200C may be changed to a second state after the prescribed latency.

In this exemplary embodiment, the first semiconductor memory device 3100C may receive a first information transmission signal TS_1 and the first chip selection signal CS_0 activating the first semiconductor memory device 3100C. The state-based decoder 3115C of the first semiconductor memory device 3100C may determine that the first semiconductor memory device 3100C is in a first state and may decode the first information transmission signal TS_1 into a first internal command signal CMD_5. The first internal command signal CMD_5 may be a transmission signal to transmit a first internal temperature information TempData_A generated by sensing an internal temperature of the first semiconductor memory device 3100C via the temperature sensor 3152C to the second semiconductor memory device 3200C. Therefore, the first semiconductor memory device 3100C may transmit the first internal temperature information TempData_A via the data bus DQ to the second semiconductor memory device 3200C in response to the first information transmission signal TS_1 after the prescribed latency. In this exemplary embodiment, the first semiconductor memory device 3100C may operate in a transmission mode Tx_mode.

In this exemplary embodiment, the second semiconductor memory device 3200C may receive the first information transmission signal TS_1 and the second chip selection signal CS_1 activating the second semiconductor memory device 3200C. The state-based decoder 3215C of the second semiconductor memory device 3200C may determine that the second semiconductor memory device 3200C is in a second state and may decode the first information transmission signal TS_1 into a second internal command signal CMD_6. The second internal command signal CMD_6 may be a received signal which causes a data input/output device 3240C of the second semiconductor memory device 3200C to receive the first internal temperature information TempData_A. Therefore, the second semiconductor memory device 3200C may receive the first internal temperature information TempData_A via the data bus DQ in response to the first information transmission signal TS_1 after the prescribed latency. As such, in this exemplary embodiment, the second semiconductor memory device 3200C may operate in a reception mode Rx_mode.

In this exemplary embodiment, a temperature-based setter 3254C of the second semiconductor memory device 3200C may receive the first internal temperature information TempData_A via the data input/output unit 3240C. In this exemplary embodiment, the temperature-based setter 3254C may receive internal temperature information of the second semiconductor memory device 3200C from a temperature sensor 3252C of the second semiconductor memory device 3200C. The temperature-based setter 3254C may compare the first internal temperature information TempData_A with the internal temperature information of the second semiconductor memory device 3200C, and may set a parameter of the second semiconductor memory device 3200C based on the comparison result. For example, the temperature-based setter 3254C may set a data input/output speed or a data read/write speed of the second semiconductor memory device 3200C according to higher temperature information of the first internal temperature information TempData_A and the internal temperature information of the second semiconductor memory device 3200C.

Afterwards, the first semiconductor memory device 3100C, which is in a first state, may receive the second state changing signal A SCA_2 and the first chip selection signal CS_0 activating the first semiconductor memory device 3100C through the shared command/address bus CA. Therefore, the first semiconductor memory device 3100C may be changed to a second state after the prescribed latency. The second semiconductor memory device 3200B, which is in a second state, may receive the second state changing signal A SCA_2 and the second chip selection signal CS_1 activating the second semiconductor memory device 3200C through the shared command/address bus CA. Therefore, the second semiconductor memory device 3200C may be changed to a first state after the prescribed latency.

In this exemplary embodiment, the second semiconductor memory device 3200C may receive a second information transmission signal TS_2 and the second chip selection signal CS_1 activating the second semiconductor memory device 3200C. The state-based decoder 3215C of the second semiconductor memory device 3200C may determine that the second semiconductor memory device 3200C is in a first state and may decode the second information transmission signal TS_2 into the first internal command signal CMD_5. The first internal command signal CMD_5 may be a transmission signal to transmit a second internal temperature information TempData_B generated by sensing an internal temperature of the second semiconductor memory device 3200C via the temperature sensor 3252C to the first semiconductor memory device 3100C. Therefore, in this exemplary embodiment, the second semiconductor memory device 3200C may transmit the second internal temperature information TempData_B via the data bus DQ to the first semiconductor memory device 3100C in response to the second information transmission signal TS_2 after the prescribed latency. As such, in this exemplary embodiment, the second semiconductor memory device 3200C may operate in a transmission mode Tx_mode.

In this exemplary embodiment, the first semiconductor memory device 3100C may receive the second information transmission signal TS_2 and the first chip selection signal CS_0 activating the first semiconductor memory device 3100C. The state-based decoder 3115C of the first semiconductor memory device 3100C may determine that the first semiconductor memory device 3100C is in a second state and may decode the second information transmission signal TS_2 into the second internal command signal CMD_6. The second internal command signal CMD_6 may be a received signal which causes a data input/output device 3140C of the first semiconductor memory device 3100C to receive the second internal temperature information TempData_B. Therefore, the first semiconductor memory device 3100C may receive the second internal temperature information TempData_B via the data bus DQ in response to the second information transmission signal TS_2 after the prescribed latency. As such, in this exemplary embodiment, the first semiconductor memory device 3100C may operate in a reception mode Rx_mode.

Afterwards, the temperature-based setter 3154C of the first semiconductor memory device 3100C may receive the second internal temperature information TempData_B via the data input/output unit 3140C. In this exemplary embodiment, the temperature-based setter 3154C may receive internal temperature information of the first semiconductor memory device 3100C from the temperature sensor 3152C of the first semiconductor memory device 3100C. The temperature-based setter 3154C may compare the second internal temperature information TempData_B with the internal temperature information of the first semiconductor memory device 3100C, and may set a parameter of the first semiconductor memory device 3100C based on the comparison result. For example, the temperature-based setter 3154C may set a data input/output speed or a data read/write speed of the first semiconductor memory device 3100C according to higher temperature information of the second internal temperature information TempData_B and the internal temperature information of the first semiconductor memory device 3100C. For example, according to an exemplary embodiment, if the temperature-based setter 3154C determines that the internal temperature information of the first semiconductor memory device 3100C is lower than the second internal temperature information TempData_B, the temperature-based setter 3154C may set a first data input/output speed or a first data read/write speed for the first semiconductor device 3100C and if the temperature-based setter 3154C determines that the internal temperature information of the first semiconductor memory device 3100C is higher than the second internal temperature information TempData_B, the temperature-based setter 3154C may set a second data input/output speed or a second data read/write speed for the first semiconductor device 3100C. In this exemplary embodiment, the first data input/output speed is different than the second data input/output speed and the second data read/write speed is different than the second data read/write speed.

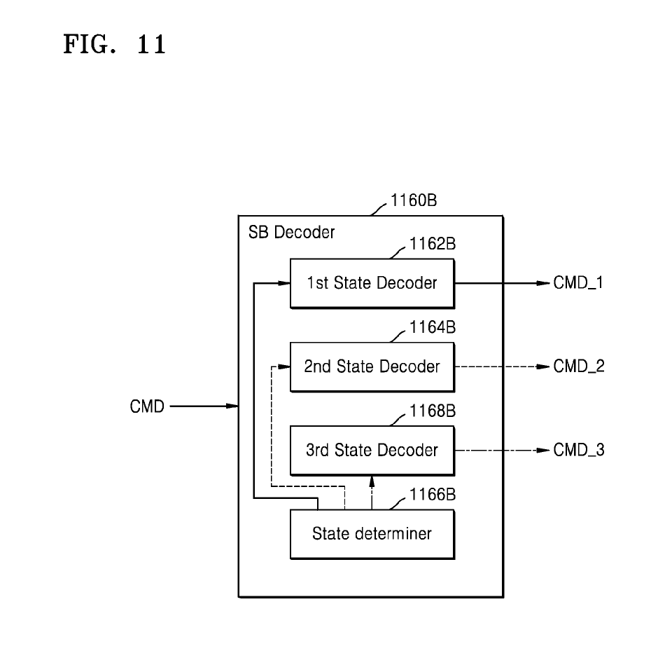

FIG. 11 is a block diagram of a state-based decoder 1160B according to another embodiment of the inventive concept. As illustrated in FIG. 11, the state-based decoder 1160B may include a first state decoder 1162B, a second state decoder 1164B, a third state decoder 1168B, and a state determiner 1166B. The state determiner 1166B may determine a state of a semiconductor memory device and control a decoding operation corresponding to a command signal CMD based on the state of the semiconductor memory device. The configuration of the first and second state decoders 1162B and 1164B may be similar to the configuration of the first and second state decoders 1162A and 1164B, respectively, as illustrated above in FIG. 4. Thus, operations of the first and second state decoders 1162B and 1164B are omitted. According to this exemplary embodiment, when the state of the semiconductor memory device is in a third state, the state determiner 1166B may control the third state decoder 1168B to decode the command signal CMD into a third internal command signal CMD_3. In this exemplary embodiment, according to the state of the semiconductor memory device, the state determiner 1166B may control the decoding operation by controlling on/off of the third state decoder 1168B.

In an exemplary embodiment, a first state may be a target state indicating a state of a semiconductor memory device to be controlled by a write operation or a read operation, a second state may be a non-target state indicating a state of a semiconductor memory device not to be controlled by a write operation or a read operation, and a third state may be a target preparation state indicating a state of a semiconductor memory device to be controlled by a preparation operation for a write operation or a read operation. For example, the preparation operation may be a data-training operation and will be described below in detail.

In this exemplary embodiment, when the command signal CMD is a state changing signal and a state of the semiconductor memory device changes to another state, the state determiner 1166B may determine the changed state and control a decoding operation corresponding to a command signal CMD based on the changed state when the command signal CMD is received again.

According to an exemplary embodiment of the inventive concept, when the semiconductor memory device is in a first state and the state-based decoder 1160B receives a state changing signal A, the state determiner 1166B may determine that the semiconductor memory device is in a second state. When the semiconductor memory device is in a second state and the state-based decoder 1160B receives a state changing signal B, the state determiner 1166B may determine that the semiconductor memory device is in a third state. When the semiconductor memory device is in a second state and the state-based decoder 1160B receives a state changing signal A, the state determiner 1166B may determine that the semiconductor memory device is in a first state. When the semiconductor memory device is in a third state and the state-based decoder 1160B receives a state changing signal A, the state determiner 1166B may determine that the semiconductor memory device is in a first state.

According to an exemplary embodiment of the inventive concept, the state-based decoder 1160B may decode the command signal CMD into first to third internal command signals CMD_1, CMD_2 and CMD_3 based on a state of the semiconductor memory device. When decoding the command signal CMD into the first internal command signal CMD_1, the semiconductor memory device may perform a first operation in response to the first internal command signal CMD_1. When decoding the command signal CMD into the second internal command signal CMD_2, the semiconductor memory device may perform a second operation in response to the second internal command signal CMD_2. When decoding the command signal CMD into the third internal command signal CMD_3, the semiconductor memory device may perform a third operation in response to the third internal command signal CMD_3.

As such, the semiconductor memory device according to an exemplary embodiment of the inventive concept, which includes the state-based decoder 1160B, may reduce the number of retransmission times of a command signal by decoding the command signal into an internal command signal according to a state of the semiconductor memory device.

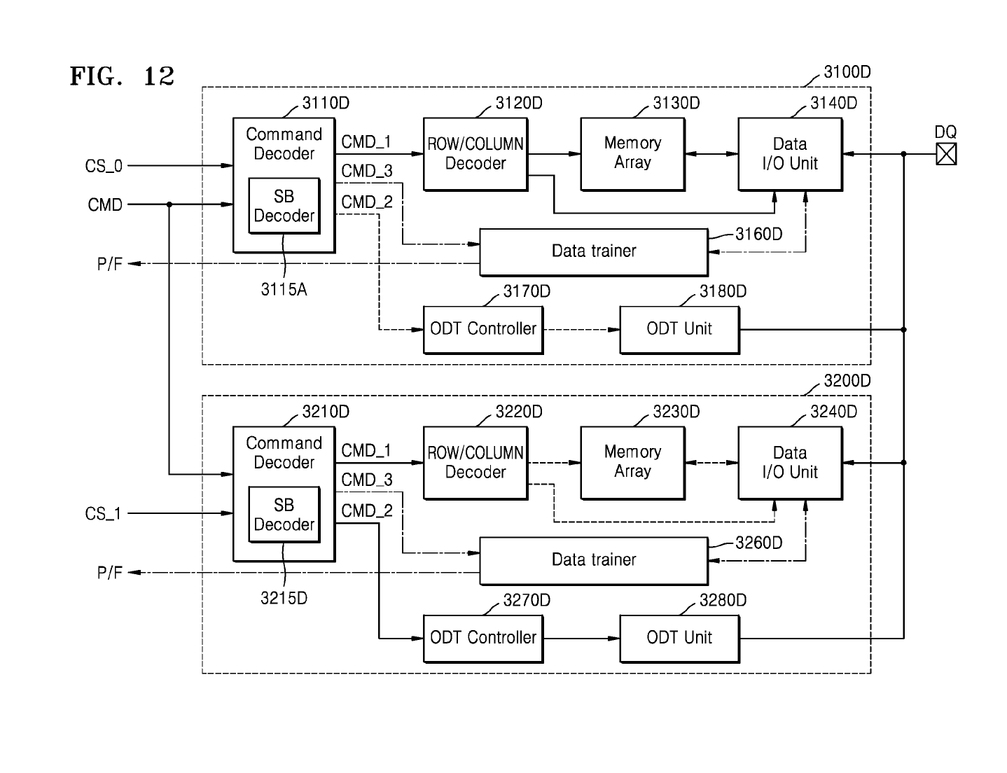

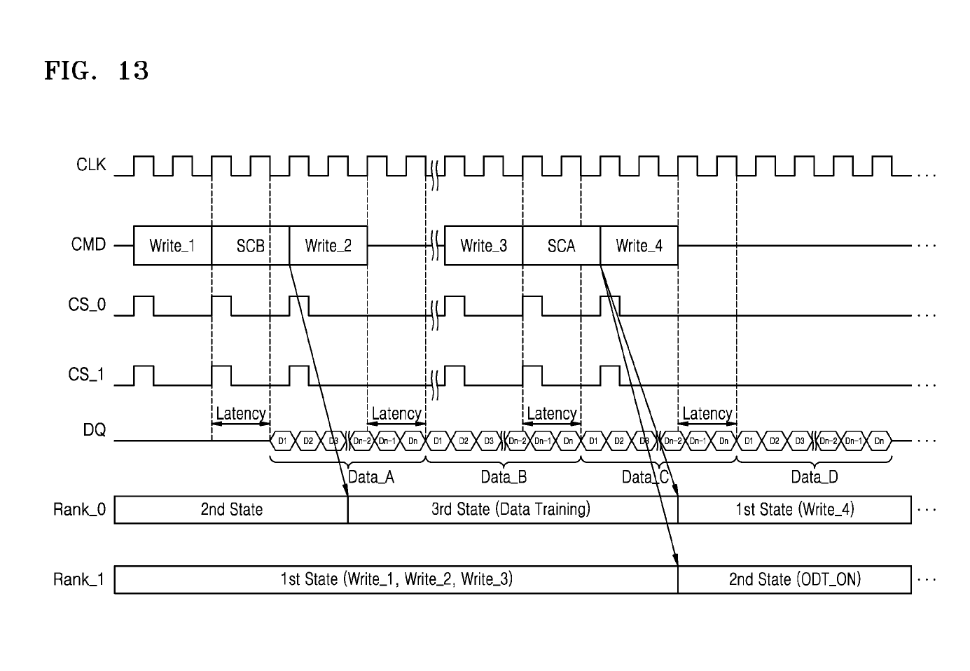

FIG. 12 is a block diagram illustrating operations of first and second semiconductor memory devices 3100D and 3200D respectively included in first and second memory groups, according to another embodiment of the inventive concept. FIG. 13 is a timing chart illustrating operations of the first and second semiconductor memory devices 3100D and 3200D of FIG. 12, according to an exemplary embodiment of the inventive concept.

As illustrated in FIG. 12, in this exemplary embodiment, the first semiconductor memory device 3100D is included in the first memory group 1100 of FIG. 1, and the second semiconductor memory device 3200D is included in the second memory group 1200 of FIG. 1.

In this exemplary embodiment, the first semiconductor memory device 3100D may include a command decoder 3110D, a row/column decoder 3120D, a memory array 3130D, a data input/output unit 3140D, a data training unit 3160D (e.g. a data training circuitry), an ODT controller 3170D, and an ODT unit 3180D (e.g., an ODT circuitry). The command decoder 3110D may include a state-based decoder 3115D. The second semiconductor memory device 3200D may have same configuration as the first semiconductor memory device 3100D. For example, in this exemplary embodiment, the second semiconductor memory device 3200D may include a command decoder 3210D, a row/column decoder 3220D, a memory array 3230D, a data input/output unit 3240D, a data training unit 3260D (e.g. a data training circuitry), an ODT controller 3270D, and an ODT unit 3280D (e.g., an ODT circuitry). The command decoder 3210D may include a state-based decoder 3215D. In this exemplary embodiment, the first and second semiconductor memory devices 3100D and 3200D may share a command/address bus CA and a data bus DQ and may receive a command signal CMD through the command/address bus CA and a data signal through the data bus DQ. A first chip selection signal CS_0 selecting the first semiconductor memory device 3100D and a second chip selection signal CS_1 selecting the second semiconductor memory device 3200D may be respectively received through different buses. For example, the command decoder 3110D of the first semiconductor device 3100D may receive the first chip selection signal CS_0 via a first bus and the command decoder 3210D of the second semiconductor device 3200D may receive the second chip selection signal CS_1 via a second bus different from the first bus.

Referring to FIGS. 12 and 13, in this exemplary embodiment, the first semiconductor memory device 3100D, which is in a second state, may receive a first write signal Write_1 and the first chip selection signal CS_0 activating the first semiconductor memory device 3100D through the command/address bus CA. Since the first semiconductor memory device 3100D is in a second state, the first semiconductor memory device 3100D may, as described above (e.g., the embodiments of FIGS. 5 and 6), turn on the ODT unit 3180D in response to the first write signal Write_1.

The second semiconductor memory device 3200D may receive the first write signal Write_1 and the second chip selection signal CS_1 activating the second semiconductor memory device 3200D. Since the second semiconductor memory device 3200D is in a first state, the second semiconductor memory device 3200D may, as described above (e.g., the embodiments of FIGS. 7 and 8), write first data Data_A sent from the data bus DQ to a data input/output unit 3240D in a memory array 3230D after the prescribed latency.

The first semiconductor memory device 3100D, which is in a second state, may receive a state changing signal B SCB and the first chip selection signal CS_0 activating the first semiconductor memory device 3100D through the command/address bus CA. Therefore, the first semiconductor memory device 3100D may be changed to a third state after the prescribed latency.

In this exemplary embodiment, the first semiconductor memory device 3100D may receive a second write signal Write_2 and the first chip selection signal CS_0 activating the first semiconductor memory device 3100D. The state-based decoder 3115D of the first semiconductor memory device 3100D may determine that the first semiconductor memory device 3100D is in a third state and may decode the second write signal Write_2 to a third internal command signal CMD_3. The third internal command signal CMD_3 may be a data training signal for performing a data-training operation before performing a data-write operation on the memory array 3130D. The data training unit 3160D may perform a data-training operation in response to the third internal command signal CMD_3 which is a data training signal. In an exemplary embodiment, the data training unit 3160D may perform a data-training operation by varying prescribed data signals, determining whether the data signals match a fixed data pattern, and outputting a pass/fail signal P/F according to the determination result. The prescribed data signals may use second data Data_B or third data Data_C received from the data bus DQ.

Since, according to this exemplary embodiment, the second semiconductor memory device 3200D is in a first state and does not receive the state changing signal B SCB, the second semiconductor memory device 3200D may also maintain the first state in the future. Therefore, the second semiconductor memory device 3200D, in response to second and third write signals Write_2 and Write_3, may write the second data Data_B and the third data Data_C sent from the data bus DQ to the data input/output unit 3140D in the memory array 3130D after the prescribed latency.

Afterwards, the first semiconductor memory device 3100D, which is in a third state, may receive a state changing signal A SCA and the first chip selection signal CS_0 activating the first semiconductor memory device 3100D through the command/address bus CA. Therefore, the first semiconductor memory device 3100D may be changed to a first state after the prescribed latency. The second semiconductor memory device 3200D, which is in a first state, may receive the state changing signal A SCA and the second chip selection signal CS_1 activating the second semiconductor memory device 3200D through the command/address bus CA. Therefore, the second semiconductor memory device 3200D may be changed to a second state after the prescribed latency.

In this exemplary embodiment, the first semiconductor memory device 3100D may receive a fourth write signal Write_4 and the first chip selection signal CS_0 activating the second semiconductor memory device 3100D. Since the first semiconductor memory device 3100D is in a first state, the first semiconductor memory device 3100D may, as described above, write fourth data Data_D sent from the data bus DQ to the data input/output unit 3140D in the memory array 3130D after the prescribed latency.

The second semiconductor memory device 3200D, which is in a second state, may receive the fourth write signal Write_4 and the second chip selection signal CS_1 activating the second semiconductor memory device 3200D through the command/address bus CA. Since the second semiconductor memory device 3200D is in a second state, the second semiconductor memory device 3200D may, as described above, turn on the ODT unit 3280D in response to the fourth write signal Write_4.

Therefore, even though the same command signal is received, the first and second semiconductor memory devices 3100D and 3200D may perform respective operations according to respective states thereof. As a result, the number of retransmission times of the command signal may decrease and efficiency of the command/address bus CA may increase.

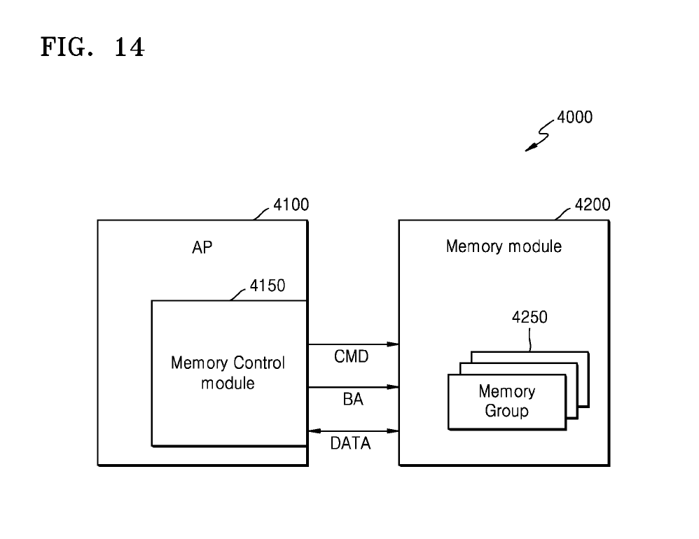

FIG. 14 illustrates a data process system 4000 including a memory controller and a memory module 4200 according to an exemplary embodiment of the inventive concept.

As illustrated in FIG. 14, the data process system 4000 may include an application processor as a host and the memory module 4200. The memory module 4200 may include a variety of types of memory devices, for example, DRAM according to embodiments, or various memory devices requiring a refresh operation (i.e., non-volatile memory such as resistive memory). Furthermore, not shown in FIG. 14, a memory device according to an exemplary embodiment of the inventive concept may be embedded memory in an application processor 4100.

In some embodiments, the application processor 4100 may be a system on chip (SoC). The SoC may include a system bus using a protocol according to a prescribed bus standard, and may further include various intellectual property (IP) blocks connected to the system bus. The AMBA™ (Advanced Micro-controller Bus Architecture System) by Advanced RISC Machines (ARM) Ltd. may be applied as a standard of a system bus. Bus types of the AMBA protocol may include Advanced High-Performance Bus (AHB), Advanced Peripheral Bus (APB), Advanced eXtensible Interface (AXI), AXI4, AXI Coherency Extensions (ACE), and so on. The bus types of the AMBA protocol may further include different types of protocols such as uNetwork by SONICs Inc., CoreConnect by IBM, or Open Core Protocol by OCP-IP (Open Core Protocol International Partnership).

In some embodiments, the application processor 4100 may include a memory control module 4150 for controlling a memory device 4200, and the memory control module 4150 may correspond to the memory controller according to the embodiments described above. In some embodiments, the memory module 4200 may include a plurality of memory regions 4250 respectively including memory cells, and each of the memory regions 4250 may correspond to the memory groups described above. Therefore, based on an identical command signal provided by the memory control module 4150, the memory regions 4250 may perform different operations according to respective states thereof.

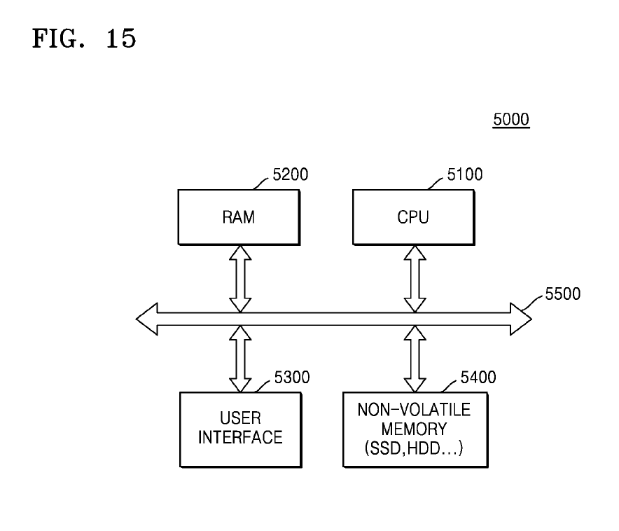

FIG. 15 is a block diagram of a computing system 5000 including a memory system, according to an exemplary embodiment of the inventive concept. A memory device according to this exemplary embodiment may be provided in the computing system 5000 such as a mobile device or a desktop computer as random access memory (RAM) 5200. The RAM 5200 may be applied to any one of the embodiments described above. A memory controller according to an exemplary embodiment of the inventive concept may be provided in the RAM 5200 or a central processing unit (CPU) 5100.

The computing system 5000 according to an exemplary embodiment of the inventive concept includes the CPU 5100, the RAM 5200, a user interface 5300, and a non-volatile memory 5400, and all of the components may be respectively electrically connected to a bus 5500, respectively. The non-volatile memory 5400 may be a mass storage device such as a solid state drive (SSD) or a hard disk drive (HDD).

By applying the memory device (or the memory system) according to an exemplary embodiment of the inventive concept to the computing system 5000, as described above, a memory module in the RAM 5200 may receive one command signal and perform different operations according to a state thereof.

While the inventive concept has been particularly shown and described with reference to embodiments thereof, it will be understood that various changes in form and details may be made therein without departing from the spirit and scope of the following claims.

What is claimed is:

1. A memory module comprising:
a first memory group comprising a plurality of first semiconductor memory devices; and
a second memory group comprising a plurality of second semiconductor memory devices,
wherein the first semiconductor memory devices included in the first memory group and the second semiconductor memory devices included in the second memory group are configured to share a command/address bus, and
wherein the first semiconductor memory devices of the first memory group are configured to perform a first operation in response to a command signal received by the first semiconductor memory devices from the command/address bus and the second semiconductor memory devices of the second memory group are configured to perform a second operation, different from the first operation, in response to the same command signal received by the second semiconductor memory devices from the command/address bus.

2. The memory module of claim 1, wherein each of the first and second memory groups is configured such that each of the first and second operations is performed in units of memory ranks.

3. The memory module of claim 1, wherein
each of the first semiconductor memory devices is configured to perform the first operation in response to the command signal when the respective first semiconductor device is in a first state, and each of the second semiconductor memory devices is configured to perform the second operation in response to the command signal when the respective second semiconductor device is in a second state.

4. The memory module of claim 3, wherein
each of the second semiconductor memory devices comprises an on-die termination (ODT) unit,
the command signal is a read or write signal, and
the first operation is a data read/write operation, and the second operation is a turn-on operation of an ODT unit.

5. The memory module of claim 3, wherein
each of the first and second semiconductor memory devices comprises a data input/output unit, and
each of the first and second memory devices is configured such that when a self-test is performed on the data input/output unit,
the command signal is a read signal, and
the first operation is a read operation of test data written in each of the first semiconductor memory devices, and the second operation is a write operation of the test data which is read through the first operation into each of the second semiconductor memory devices.

6. The memory module of claim 3, wherein
each of the first semiconductor memory devices comprises a temperature sensor configured to sense an internal temperature of the respective first semiconductor memory device and generate internal temperature information, and
each of the first and second memory devices is configured such that when setting a parameter of the first and second semiconductor memory devices and the command signal is a transmission signal,
the first operation of each of the first semiconductor memory devices is a transmission operation transmitting the internal temperature information to a corresponding second semiconductor memory device, and the second operation of the each of the second semiconductor memory devices is a receiving operation receiving the internal temperature information.

7. The memory module of claim 3, wherein each of the first and second semiconductor memory devices is configured such that when receiving a first state changing signal from the command/address bus,
a state of each of the first semiconductor memory devices changes from the first state to the second state in response to the first state changing signal, and
a state of each of the second semiconductor memory devices changes from the second state to the first state in response to the first state changing signal.

8. The memory module of claim 3, wherein
each of the second semiconductor memory devices is configured such that when receiving a second state changing signal from the command/address bus,
a state of each of the second semiconductor memory devices changes from the second state to a third state in response to the second state changing signal.

9. The memory module of claim 8, wherein
each of the second semiconductor memory devices is configured to perform a third operation in response to the command signal.

10. The memory module of claim 9, wherein
the command signal is a write signal, and
the first operation is a data-write operation into the each of the first semiconductor memory devices, and the third operation is a data-training operation on the each of the second semiconductor memory devices.

11. The memory module of claim 9, wherein
each of the first and second semiconductor memory devices is configured such that when receiving a first state changing signal from the command/address bus,
a state of each of the first semiconductor memory devices changes from the first state to the second state in response to the first state changing signal, and
a state of each of the second semiconductor memory devices changes from the second state to the first state in response to the first state changing signal.

12. A semiconductor memory system comprising:
a memory module comprising a plurality of semiconductor memory devices configured to share a command/address bus; and
a controller configured to control the semiconductor memory devices by providing a command signal into the semiconductor memory devices via the command/address bus,
wherein each semiconductor memory device of the semiconductor memory devices comprises a state-based decoder configured to decode the command signal based on a state of the semiconductor memory device.

13. The semiconductor memory system of claim 12, wherein
each state-based decoder comprises:
a state determiner configured to determine a state of a corresponding semiconductor memory device;
a first state decoder configured to decode the command signal into a first internal command signal when the semiconductor memory device is in a first state; and
a second state decoder configured to decode the command signal into a second internal command signal when the corresponding semiconductor memory device is in a second state.

14. The semiconductor memory system of claim 13, wherein
each state-based decoder comprises:
a third state decoder configured to decode the command signal into a third internal command signal when the corresponding semiconductor memory device is in a third state.

15. The semiconductor memory system of claim 13, wherein
the state determiner is further configured to change the state of the corresponding semiconductor memory device into a different state upon receiving a state changing signal from the controller via the command/address bus.

16. A memory module comprising:
a first semiconductor memory device including a first state decoder; and
a second semiconductor memory device including a second state decoder,
wherein the first semiconductor memory device and the second semiconductor memory device share a command/address bus,
wherein the first state decoder is configured to decode a command signal, received via the command/address bus, into a first internal command signal, and the first semiconductor memory device is configured to perform a first type of operation based on the first internal command signal when it is determined that the first semiconductor memory device is in a first state, and
wherein the second state decoder is configured to decode the same command signal, received via the command/address bus, into a second internal command signal, and the second semiconductor memory device is configured to perform a second type of operation based on the second internal command signal when it is determined that the second semiconductor memory device is in a second state.

17. The memory module of claim 16, wherein
each of the first and second semiconductor memory devices comprises a data input/output unit, and
when a self-test is performed on the data input/output unit,
the command signal is a read signal, and
the first operation is a read operation of test data written in the first semiconductor memory device, and the second operation is a write operation of the test data which is read through the first operation into the second semiconductor memory device.

18. The memory module of claim 16, wherein
each of the first semiconductor memory devices comprises a temperature sensor configured to sense an internal temperature of the corresponding semiconductor memory device and generate internal temperature information, and
when setting a parameter of the first and second semiconductor memory devices,
the command signal is a transmission signal, and
the first operation of the first semiconductor memory device is a transmission operation transmitting the internal temperature information to the second semiconductor memory device, and the second operation of the second semiconductor memory device is a receiving operation receiving the internal temperature information.

19. The memory module of claim 16, wherein
each of the first and second semiconductor memory devices is configured to receive a first state changing signal from the command/address bus,
a state of the first semiconductor memory device changes from the first state to the second state in response to the first state changing signal, and
a state of the second semiconductor memory device changes from the second state to the first state in response to the first state changing signal.

20. The memory module of claim 16, wherein
the second semiconductor device is configured to receive a second state changing signal from the command/address bus, and
a state of the second semiconductor memory device changes from the second state to a third state in response to the second state changing signal.

21. The memory module of claim 20, wherein
the second semiconductor memory device is configured to perform a third type of operation in response to the command signal.
